(19) United States
(12) Patent Application Publication
(10) Pub. No.: US 2021/0148509 A1
(43) Pub. Date: May 20, 2021

(54) GIMBAL AND GIMBAL SYSTEM

(71) Applicant: SZ DJI TECHNOLOGY CO., LTD., Shenzhen (CN)

(72) Inventors: Hongpeng CHU, Shenzhen (CN); Hao LIU, Shenzhen (CN)

(21) Appl. No.: 17/158,730

(22) Filed: Jan. 26, 2021

Related U.S. Application Data
(63) Continuation of application No. PCT/CN2018/097886, filed on Aug. 1, 2018.

(51) Int. Cl. F16M 13/04; F16M 11/20; H01R 31/00

(52) U.S. Cl. CPC F16M 13/04; F16M 11/2028; G03B 17/561; F16M 2200/045; H01R 31/005

(57) ABSTRACT

A gimbal includes a shaft, a first connection arm, a second connection arm, a connector, and a motor. The first connection arm includes an avoidance hole. The second connection arm is rotatably connected to the first connection arm. The connector passes through the avoidance hole. Two ends of the connector are connected to the first connection arm and the second connection arm, respectively. The motor is configured to drive the first connection arm and the second connection arm to rotate relative to each other around the shaft. The connector moves in the avoidance hole.

### CROSS-REFERENCE TO RELATED APPLICATION

This application is a continuation of International Application No. PCT/CN2018/097886, filed Aug. 1, 2018, the entire content of which is incorporated herein by reference.

### TECHNICAL FIELD

The present disclosure generally relates to the mechanical stabilization technology field and, more particularly, to a gimbal and a gimbal system.

### BACKGROUND

Connection arms of a gimbal are usually connected by a shaft. A plurality of connection arms are electrically connected via wires in a hollow portion of the shaft. In order for the hollow portion to have sufficient space for wiring, a diameter of the shaft is made relatively large, which results in a relatively large volume of the gimbal, making it difficult to realize miniaturization of the gimbal and to carry the gimbal.

### SUMMARY

Embodiments of the present disclosure provide a gimbal, including a shaft, a first connection arm, a second connection arm, a connector, and a motor. The first connection arm includes an avoidance hole. The second connection arm is rotatably connected to the first connection arm. The connector passes through the avoidance hole. Two ends of the connector are connected to the first connection arm and the second connection arm, respectively. The motor is configured to drive the first connection arm and the second connection arm to rotate relative to each other around the shaft. The connector moves in the avoidance hole.

Embodiments of the present disclosure provide a gimbal system, including a gimbal and a load. The gimbal includes a shaft, a first connection arm, a second connection arm, a connector, and a motor. The first connection arm includes an avoidance hole. The second connection arm is rotatably connected to the first connection arm. The connector passes through the avoidance hole. Two ends of the connector are connected to the first connection arm and the second connection arm, respectively. The motor is configured to drive the first connection arm and the second connection arm to rotate relative to each other around the shaft. The connector moves in the avoidance hole. The load is mounted at the second connection arm. When rotating relative to the first connection arm, the second connection arm is configured to drive the load to rotate relative to the first connection arm.

### BRIEF DESCRIPTION OF THE DRAWINGS

FIG. 1 is a schematic perspective assembled view of a gimbal system in a status according to some embodiments of the present disclosure.

FIG. 2 is a schematic perspective assembled view of the gimbal system in another status according to some embodiments of the present disclosure.

FIG. 3 is a schematic enlarged view of part III of the gimbal system in FIG. 1.

FIG. 4 is a schematic enlarged view of part IV of the gimbal system in FIG. 2.

FIG. 5 is a schematic perspective exploded view of the gimbal system according to some embodiments of the present disclosure.

FIG. 6 is a schematic planar assembled view of the gimbal system according to some embodiments of the present disclosure.

FIG. 7 is a schematic cross-section view of the gimbal system along line VII-VII in FIG. 6.

FIG. 8 is a schematic enlarged view of part VIII of the gimbal system in FIG. 7.

### DETAILED DESCRIPTION OF THE EMBODIMENTS

Embodiments of the present disclosure are further described in connection with the accompanying drawings. Same or similar signs in the accompanying drawings represent same or similar elements or elements having same or similar functions.

In addition, embodiments of the present disclosure described in connection with the accompanying drawings are exemplary and merely embodiments used to describe the present disclosure but not to be understood as a limitation to the present disclosure.

In the present disclosure, unless otherwise determined and specified, a first feature “on” or “below” a second feature may include that the first feature contacts the second feature directly or indirectly via an intermediate medium. Moreover, a first feature being “above,” “on,” or “over” a second feature may include that the first feature is right or obliquely above the second feature, or a horizontal height of the first feature is higher than a horizontal height of the second feature. A first feature being “under,” “below,” or “beneath” a second feature may include that the first feature is right or obliquely under the second feature, or the horizontal height of the first feature is lower than the horizontal height of the second feature.

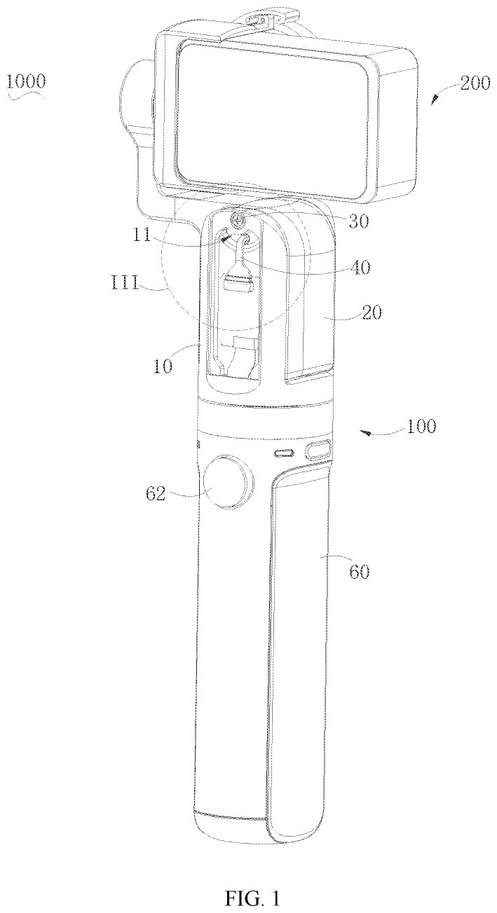

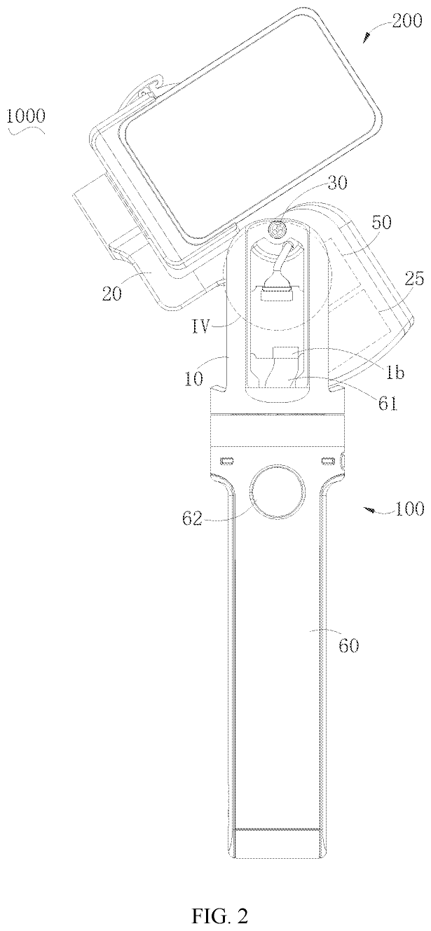

As shown in FIG. 1 and FIG. 2, a gimbal system 1000 of embodiments of the present disclosure includes a gimbal 100 and a load 200.

The load 200 is mounted at the gimbal 100. In some embodiments, the load 200 may be detachably mounted at the gimbal 100. The load 200 may communicate with the gimbal 100 via a wired connection or a wireless connection. The load 200 may also not communicate with the gimbal 100. Different loads 200 may be chosen to be carried at the gimbal 100 according to different application requirements of the gimbal system 1000. For example, the load 200 may include an imaging device, such as a visible light camera, a cell phone having a photographing function, a depth camera, an infrared camera, etc. For another example, the load 200 may include a display device, such as a cell phone having a display function, a game console, a smartwatch, a projecting display device, etc. The load 200 may include a device having the imaging function and the display function or a device configured to realize other functions, for example, a flashlight, a radar, etc. Hereinafter, embodiments are described with the load 200 being an imaging device having a display function as an example.

The gimbal 100 may be configured to carry the load 200. The gimbal 100 may move to drive the load 200 to move to change a direction and a position of the load 200 of collecting or transmitting data. In some embodiments, the gimbal 100 may move to change the direction of the imaging device for collecting images, and to drive an angle of the imaging device for displaying the image to change. The gimbal 100 may include a handheld gimbal. A user may hold the gimbal 100 with one hand or both hands. The gimbal 100 may be an on-board gimbal. The gimbal 100 may be carried at an unmanned machine, for example, an unmanned aerial vehicle (UAV), an unmanned vehicle, an unmanned ship, etc. In some embodiments, for example, the gimbal 100 is described as a handheld gimbal 100. The gimbal 100 includes a first connection arm 10, a second connection arm 20, a shaft 30, a connector 40, and a motor 50.

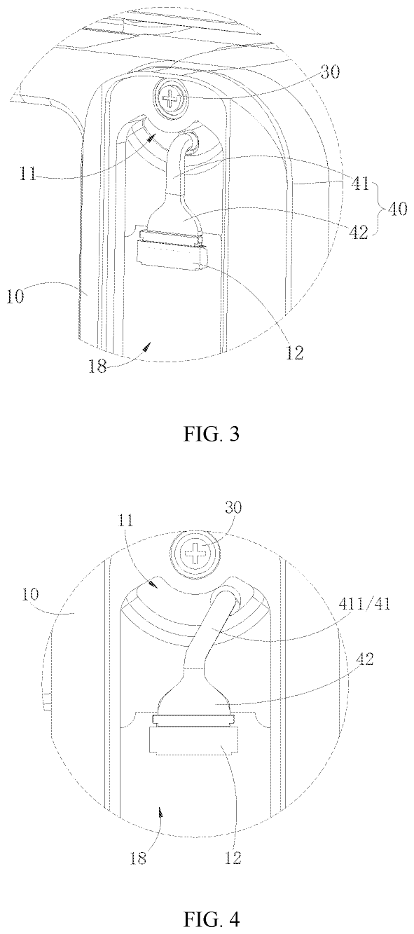

As shown in FIG. 3 and FIG. 4, the first connection arm 10 includes an avoidance hole 11. The second connection arm 20 is rotatably connected to the first connection arm 10. The connector 40 passes through the avoidance hole 11. Two ends of the connector 40 are connected to the first connection arm 10 and the second connection arm 20, respectively. The motor 50 may be configured to drive the first connection arm 10 and the second connection arm 20 to rotate relative to each other around the shaft 30. The connector 40 may move in the avoidance hole 11.

In the gimbal system 1000 of embodiments of the present disclosure, the connector 40 passes through the avoidance hole 11 to connect the first connection arm 10 and the second connection arm 20. When the first connection arm 10 and the second connection arm 20 rotate relative to each other, the connector 40 may move in the avoidance hole 11. Since a space may not need to be formed in the shaft 30 for the connector 40 to pass through, a diameter of the shaft 30 may be made relatively small, which is beneficial for the miniaturization of the gimbal 100 and the gimbal 100 may be convenient to carry.

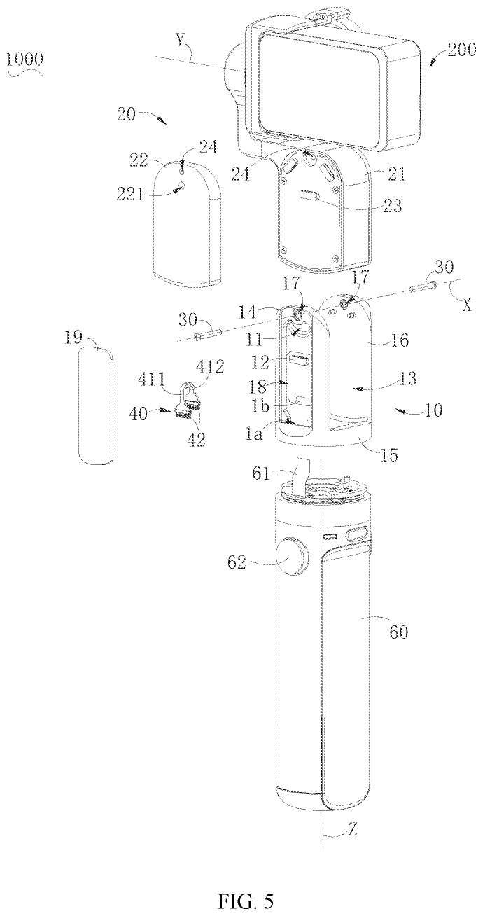

As shown in FIG. 5, the first connection arm 10 includes an avoidance space 13, which may prevent interference between the first connection arm 10 and the second connection arm 20 when the first connection arm 10 and the second connection arm 20 rotate relative to each other. The avoidance hole 11 communicates with the avoidance space 13 to cause a portion of the connector 40 to be located in the avoidance space 13 and another portion of the connector 40 to be located outside the avoidance space 13 after the connector 40 passes through the avoidance hole 11. In some embodiments, the first connection arm 10 includes a first wall 14, a connection wall 15, and a second wall 16 connected in sequence. The first wall 14, the connection wall 15, and the second wall 16 form a U shape as a whole. The first wall 14 and the second wall 16 are arranged at an interval to form the avoidance space 13. The height of the first wall 14 and a height of the second wall 16 may be the same or different. Two ends of the connection wall 15 are connected to the first wall 14 and the second wall 16, respectively.

In some embodiments, the avoidance hole 11 is arranged at the first wall 14. The avoidance hole 11 communicates with two sides of the first wall 14. After the connector 40 passes through the avoidance hole 11, a portion of the connector 40 is located on one side of the first wall 14, and another portion of the connector 40 is located on the other side of the first wall 14. In some embodiments, a portion of the connector 40 is located in the avoidance space 13, and another portion of the connector 40 is located outside the avoidance space 13. The two portions pass through the avoidance hole and are connected to each other. In some other embodiments, the avoidance hole 11 may be arranged at the first wall 14 and may not pass through the first wall 14. For example, the avoidance hole 11 may be arranged on one side of the first wall 14, and the first wall 14 may include a hollow chamber. The avoidance hole 11 may communicate with the avoidance space 13 and the hollow chamber. The user may insert the connector 40 from the avoidance hole 11 into the hollow chamber to be connected to the first arm 10.

In some other embodiments, the avoidance hole 11 may be arranged at the first wall 16. The connector 40 may pass through the avoidance hole 11 to pass through the second wall 16. In some other embodiments, the avoidance holes 11 may be arranged at both of the first wall 14 and the second wall 16. At least one connector 40 may pass through the avoidance hole 11 at the first wall 14 to pass through the first wall 14, and at least one connector 40 may pass through the avoidance hole 11 at the second wall 16 to pass through the second wall 16. When the avoidance hole 11 is arranged at the second wall 16, the avoidance hole 11 may not pass through the second wall 16. For example, the avoidance hole 11 may be arranged on one side of the second wall 16. The second wall 16 may include a hollow chamber. The avoidance hole 11 may communicate with the avoidance space 13 and the hollow chamber. The user may insert the connector 40 from the avoidance hole 11 into the hollow chamber to be connected to the first connection arm 10.

A first connection base 12 is mounted at the first connection arm 10. The first connection base 12 may be configured as a portion of the first connection arm 10. The first connection base 12 may include a plug configured for an electrical connection. Pins of the first connection base 12 may be connected to an electronic device mounted at the first connection arm 10. In some embodiments, the first connection base 12 is arranged at the first wall 14.

As shown in FIG. 1, FIG. 2, and FIG. 5, the second connection arm 20 is rotatably connected to the first connection arm 10. The second connection arm 20 is rotatably connected to the first connection arm 10 by the shaft 30. The second connection arm 20 may be partially located in the avoidance space 13 and partially located outside the avoidance space 13. In some embodiments, the second connection arm is in a Z shape as a whole. An end of the second connection arm 20 is located in the avoidance space 13, and another end of the second connection arm 20 is connected to the load 200. When the second connection arm 20 rotates relative to the first connection arm 10, the second connection arm 20 may drive the load 200 to rotate relative to the first connection arm 10. The second connection arm 20 and the load 200 may be rotatably connected.

In some embodiments, the second connection arm 20 includes a body 21 and a cover 22. The cover 22 is detachably mounted at the body 21. When the second connection arm 20 and the first connection arm 10 are assembled, the cover 22 is located between the body 21 and the first wall 14. The cover 22 includes a through-hole 221. A position of the through-hole 221 corresponds to a position of the avoidance hole 11. After passing through the avoidance hole 11, the connector 40 passes through the through-hole 221 to pass through the cover 22 to be further connected to the body 21. A shape of the through-hole 221 may include a circle, an oval, a rectangle, etc. In some embodiments, a centerline of the through-hole 221 may be in an arc shape. The centerline of the through-hole 221 is centered on the shaft 30. When the second connection arm 20 and the first connection arm 10 rotate relative to each other around the shaft 30, the connector 40 may move in the through-hole 221. The through-hole 221 with the centerline in the arc shape may cause the second connection arm 20 and the first connection arm 10 to rotate relative to each other with a greater angle.

A second connection base 23 is mounted at the second connection arm 20. The second connection base 23 may be configured as a portion of the second connection arm 20. The second connection base 23 may include a plug configured for the electrical connection. Pins of the second connection base 23 may be connected to an electronic device mounted at the second connection arm 20. In some embodiments, the second connection base 23 may be arranged at the body 21. One or more second connection bases 23 may be included. After the cover 22 is mounted at the body 21, the cover may prevent dust and water vapor from entering the second connection base 23 to improve the overall sealing of the gimbal 100.

As shown in FIG. 5, the shaft 30 is rotatably connected to the first connection arm 10 and the second connection arm 20. The shaft 30 may be configured as a yaw axis Z of the gimbal 100. The shaft 30 may be configured as a roll axis X of the gimbal 100. The shaft 30 may be configured as a pitch axis Y of the gimbal 100. A plurality of shafts 30 may be included. The plurality of shafts 30 may be configured as at least two of the yaw axis Z, the roll axis X, or the pitch axis Y, which are not limited here. In some embodiments, the roll axis X is described as an example of the shaft 30.

In some embodiments, the shaft 30 passes through the first connection arm 10 and the second connection arm 20 to rotatably connect to the first connection arm 10 and the second connection arm 20. In some embodiments, the first connection arm 10 includes a first shaft hole 17, the second connection arm 20 includes a second shaft hole 24, and the second shaft hole 24 may be aligned with the first shaft hole 17. In some embodiments, the first shaft hole 17 is arranged at the first wall 14 and the second wall 16, and the second shaft hole 24 is arranged at the cover 22 and the body 21. The shaft 30 passes through the first shaft hole 17 and the second shaft hole 24. Two shafts 30 may be included. One shaft 30 passes through the first shaft hole 17 at the first wall 14, the second shaft hole 24 at the cover 22, and the second shaft hole 24 at the body 21 in sequence. The other shaft 30 passes through the first shaft hole 17 at the second wall 16 and the second shaft hole 24 at the body 21 in sequence.

The shaft 30 is rotatably connected to the first wall 14 and the second wall 16. The shaft 30 is fixedly connected to the second connection arm 20. In some embodiments, bearings are mounted in the first shaft hole 17, and the shaft 30 passed through the first shaft hole 17 and is rotatably connected to the first wall 14 and the second wall 16 through the bearings. After being inserted into the second shaft hole 24, the shaft 30 is fixedly connected to the second connection arm 20. For example, the shaft 30 may include a screw. The shaft 30 is inserted in the second shaft hole 24 and may be connected to the second connection arm 20 by a threaded connection. When the second connection arm 20 and the first connection arm 10 rotate relative to each other, the shaft 30 may rotate with the second connection arm 20 synchronously.

In some other embodiments, the shaft 30 may be fixedly connected to the first connection arm 10 and rotate with the first connection arm 10 synchronously. Further, the shaft 30 may be rotatably connected to the second connection arm 20. The first shaft hole 17 may only be arranged at the first wall 14 or on the second wall 16. A single shaft 30 may be included. A specific form of the shaft 3 may not be limited to the above examples, as long as the shaft 3 may rotatably connect the first connection arm 10 and the second connection arm 20.

In some other embodiments, the first connection arm 10 and the second connection arm 20 may include opposite connection structures. For example, the second connection arm 20 may include the first wall, the connection wall, and the second wall and form a recessed structure. The first connection arm 10 may include a protrusion structure and be located in the avoidance space formed by the first wall, the connection wall, and the second wall. The recessed structure of the first connection arm 10 may cooperate with the protrusion structure of the second connection arm 20 and the recessed structure of the first connection arm 10 and the protrusion structure of the second connection arm 20 may rotate relative to each other around the shaft 30. Correspondingly, the avoidance hole 11 may be arranged at at least one of the first wall or the second wall. An end of the connector 40 is connected to the first connection arm 10 in the avoidance space 13 through the avoidance hole 11, and another end of the connector 40 is connected to the first wall or the second wall of the second connection arm 20. As such, a connection function same as a connection function of the connection structure of the first connection arm 10 and the second connection arm 20 may be realized.

As shown in FIG. 5 to FIG. 8, the connector 40 passes through the avoidance hole 11. A portion of the connector 40 is located in the avoidance space 13, and another portion is located outside the avoidance space 13. The two ends of the connector 40 are connected to the first connection arm 10 and the second connection arm 20, respectively. In some embodiments, the connector 40 may further pass through the through-hole 221 of the cover 22. In some embodiments, the cover 22 may be omitted. Correspondingly, the connector 40 may not need to pass through the through-hole 221. In some embodiments, the two ends of the connector 40 are electrically connected to the first connection arm 10 and the second connection arm 20 to cause the first connection arm 10 to be connected to the second connection arm 20 through the connector 40 to transmit an electrical signal, or the devices mounted at the first connection arm 10 and the second connection arm 20 may be connected through the connector 40 to transmit the electrical signal. The connector 40 may also be physically connected not electrically connected to the first connection arm 10 and the second connection arm 20.

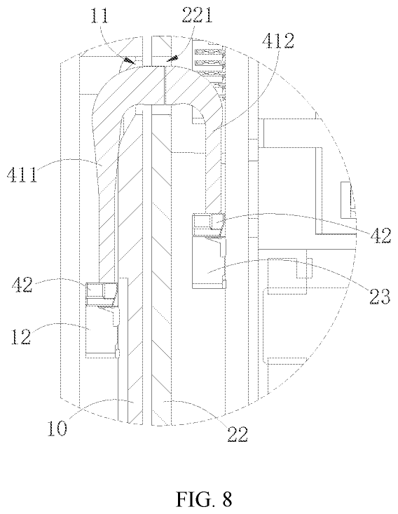

In some embodiments, the connector 40 includes a conductive wire 41 and connection heads 42. The conductive wire 41 passes through the avoidance hole 11 and the through-hole 221. When the first connection arm 10 and the second connection arm 20 rotate relative to each other, the conductive wire 41 may move in the avoidance hole 11. The connection heads 42 are arranged at two ends of the conductive wire 41. One or more connection heads 42 may be arranged at any one end of the conductive wire 41. As shown in FIG. 5 and FIG. 8, one connection head 42 is arranged at each one of the two ends of the conductive wire 41. The connection head 42 may be configured as a plug for the electrical connection. The connection head 42 located at one end of the conductive wire 41 is connected to the first connection base 12. The connection head 42 located at the other end of the conductive wire 41 is connected to the second connection base 23. As such, the connector 40 may electrically connect the first connection base 12 and the second connection base 23, that is, electrically connect the electronic device mounted at the first connection arm 10 and the electronic device mounted at the second connection arm 20.

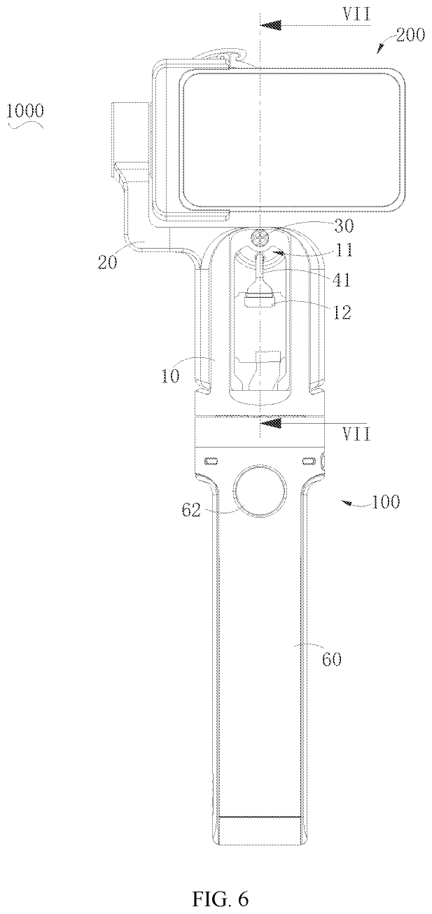

Further, as shown in FIG. 5, FIG. 6, and FIG. 8, the conductive wire 41 includes a first piece 411 and a second piece 412. The first piece 411 and the second piece 412 may be detachably connected. The first piece 411 is connected to one connection head 42, and the second piece 412 is connected to the other connection head 42. When the gimbal 100 is assembled, at first, the connection head 42 connected to the first piece 411 may be connected to the first connection base 12, and the connection head 42 connected to the second piece 412 may be connected to the second connection base 23. Then, the first piece 411 passes through the avoidance hole 11 and the through-hole 221 to be connected to the second piece 412. As such, during the assembly process, the connection head 42 does not need to pass through the avoidance hole 11 and the through-hole 221, and sizes of the avoidance hole 11 and the through-hole 221 may be designed to be relatively small.

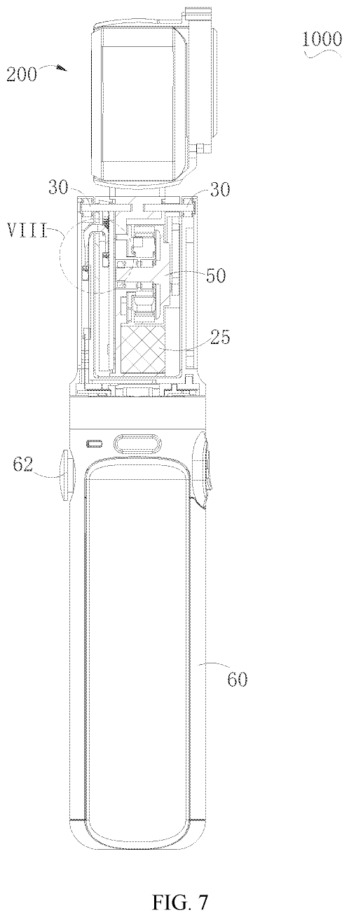

As shown in FIG. 2, FIG. 7 and FIG. 8, a motor 50 is configured to drive the first connection arm 10 and the second connection arm 20 to rotate relative to each other. In some embodiments. the motor 50 may include a brushless motor, a step motor, etc. The motor 50 is mounted at the second connection arm 20. The motor 50 and the load 200 are mounted at two opposite sides of the shaft 30. Thus, the motor 50 may be configured as a portion of the weight. The motor 50 is electrically connected to the connector 40. A control signal of the motor 50 may be transmitted to the motor 50 via the connector 40 and the second connection base 23.

When the gimbal 100 is in operation, the motor 50 may drive the second connection arm 20 and the first connection arm 10 to rotate relative to each other around the shaft 30 with the control signal transmitted by the connector 40. The load 200 may also rotate with the second connection arm 20. FIG. 1 and FIG. 2 are schematic diagrams showing the statuses of the second connection arm 20 and the first connection arm 10 when rotating relative to each other to different angles. In connection with FIG. 3 and FIG. 4, when the second connection arm 20 and the first connection arm 10 rotate relative to each other to the different angles, the position of the connector 40 in the avoidance hole 11 may change correspondingly. In some embodiments, the connection heads 42 may be connected to the first connection base 12 and the second connection base 23 all the time. The conductive wire 41 may move in the avoidance hole 11 to adapt to the relative rotation of the first connection arm 10 and the second connection arm 20.

In summary, the connector 40 of the gimbal 100 passes through the avoidance hole 11 to connect the first connection arm 10 and the second connection arm 20. When the first connection arm 10 and the second connection arm 20 rotate relative to each other, the connector 40 may move in the avoidance hole 11. A space may not need to be formed in the shaft 30 for the connector 40 to pass through. Thus, the diameter of the shaft 30 may be made to be relatively small, which is beneficial for the miniaturization of the gimbal 100, and the gimbal 100 is convenient to carry.

As shown in FIG. 3 and FIG. 4, in some embodiments, the centerline of the avoidance hole 11 is in an arc shape. The centerline of the avoidance hole 11 is centered on the shaft 30. In some embodiments, when the second connection arm 20 rotates relative to the first connection arm 10, the second connection arm 20 may drive the connector 40 to move in the avoidance hole 11. A trajectory of the connector 40 in the avoidance hole 11 may be in an arc shape centered on the shaft 30. To design the avoidance hole 11 with the arc-shaped centerline, the avoidance hole 11 may better cooperate with the trajectory of the connector 40 in the avoidance hole 11. When the connector 40 moves to an end of the avoidance hole 11, the second connection arm 20 may rotate to an extreme position in a direction. when the connector 40 moves to another end of the avoidance hole 11, the second connection arm 20 may rotate to an extreme position in another direction.

A specific shape of the avoidance hole 11 is not limited to the above and may include another shape. For example, the avoidance hole 11 may include a circle, an oval, a square, etc., as long as the avoidance hole 11 may include the space for the connector 40 to move.

As shown in FIG. 2 and FIG. 5, in some embodiments, the first shaft hole 17 is arranged at positions of the first wall 14 and the second wall 16 close to the tops. The second connection arm 20 may be configured to be connected to the load 200. The second connection arm 20 includes a weight structure 25. The weight structure 25 and the load 200 are located at the two opposite sides of the shaft 30. The positions of the first wall 14 and the second wall 16 close to the tops may include the positions of ends of the first wall 14 and the second wall 16 away from the connection wall 15. When the second connection arm 20 rotates around the shaft 30, the second connection arm 20 actually rotates around its own axis (i.e., shaft 30). The weight structure 25 and the load 200 are located at the two opposite sides of the shaft 30, which makes the second connection arm 20 rotate more steadily. Thus, the rotation angle of the second connection arm 20 may be easy to control.

As shown in FIG. 4 and FIG. 5, in some embodiments, the first wall 14 includes an accommodation slot 18. The accommodation slot 18 is arranged at the side of the first wall 14 away from the second wall 16. The avoidance hole 11 is arranged at the bottom of the accommodation slot 18. The connector 40 is partially accommodated in the accommodation slot 18. The first connection arm 10 further includes an end cover 19. The end cover 19 may be detachably mounted at the first wall 14 to shield the accommodation slot 18. In some embodiments. the first connection base 12 is mounted in the accommodation slot 18, and a portion of the connector 40 is accommodated in the accommodation slot 18, which may prevent the first connection base 12 and the connector 40 from protruding from the first wall 14. The first shaft hole 17 and the avoidance hole 11 may all be arranged at the bottom of the accommodation slot 18. By using the end cover 19 to shield the accommodation slot 18, on the one hand, the elements such as the first connection base 12 may be shielded, thus, the appearance of the gimbal 100 is aesthetic. On the other hand, the end cover 19 may facilitate the accommodation slot 18 to be sealed to prevent the dust from entering the elements such as the first connection base 12. In some other embodiments, the first wall 14 may not include the accommodation slot 18. The avoidance hole 11 may be directly arranged at an outer wall of the first wall 14. The end cover 19 may also be omitted.

As shown in FIG. 2 and FIG. 5, in some embodiments, the gimbal 100 further includes a handle 60. The handle 60 is rotatably connected to the connection wall 15. A connection hole la is arranged at the bottom of the first wall 14. The connection hole 1a communicates with the accommodation slot 15 to allow a connection wire 61 of the handle 60 to pass through the connection hole 1a. The connection wire 61 enters the accommodation slot 18 to be connected to the connection device 1b of the first connection arm 10.

The user may hold the handle 60 by hand to hold the gimbal 100. An operation component 62 is arranged at the handle 60. The operation component 62 may include a button, a joystick, a touch screen, a touchpad, etc. The user may operate at the operation component 62 to control the gimbal 100 while holding the handle 60 by hand, for example, control the first connection arm 10 to rotate relative to the handle 60, control the second connection arm 20 to rotate relative to the first connection arm 10, control the load 200 to rotate relative to the second connection arm 20, etc. The connection wire 61 may include a flexible circuit board. The connection wire 61 is connected to the connection device 1b. The connection device 1b may be electrically connected to the electronic device of the first connection arm 10, for example, electrically connected to the first connection base 12.

An operation instruction entered by the user at the handle 60 may be transmitted to the connection device 1b via the connection wire 61. Then, the operation instruction may be transmitted by the connection device 1b to the electronic device of the first connection arm 10, or be transmitted to the electronic device of the second connection arm 20 through the first connection base 12, the connector 40, and the second connection base 23. Information of operational statuses of the electronic device of the second connection arm 20 and the electronic device of the first connection arm 10 may be transmitted to the handle 60 via the connection wire 61.

The bottom of the first wall 14 may include an end of the first wall 14 connected to the connection wall 15. The connection device 1b and the connection wire 61 may all be shielded by the end cover 19 and not be exposed to the outside of the gimbal 100. Thus, the appearance of the gimbal 100 may be aesthetic, and the connection device 1b and the connection wire 61 may be prevented from being affected by external dust and water vapor.

In the description of this specification, reference terms of “certain embodiments,” “one embodiment,” “some embodiments,” “examples,” “specific examples,” “some examples,” etc., are intended to incorporate the specific features, structures, materials, or characteristics described by embodiments or examples to be included in at least one embodiment or example of the present disclosure. In this specification, the schematic representations of the terms do not necessarily refer to same embodiments or examples. Moreover, the described specific features, structures, materials, or characteristics may be combined in any one or more embodiments or examples in a suitable manner. In addition, when there is no conflict, those skilled in the art can combine and group different embodiments or examples and the characteristics of different embodiments or examples described in this specification.

In addition, the terms “first” and “second” are only used for descriptive purposes, and cannot be understood as indicating or implying relative importance or implicitly indicating the number of indicated technical features. Therefore, a feature associated with “first” and “second” may explicitly or implicitly include at least one of the feature. In the description of the present disclosure, “plurality” means at least two, such as two or three, unless otherwise specified.

Although embodiments of the present disclosure have been shown and described above, embodiments are exemplary and should not be understood to limit the present disclosure. Those of ordinary skill in the art may perform changes, modifications, replacements, and variations on embodiments. All these changes, modifications, replacements, and variations are within the scope of the present disclosure. The scope of the present invention is defined by the claims and their equivalents.

What is claimed is:

1. A gimbal comprising:
a shaft;
a first connection arm including an avoidance hole;
a second connection arm rotatably connected to the first connection arm; and
a connector passing through the avoidance hole, two ends of the connector being connected to the first connection arm and the second connection arm, respectively; and
a motor configured to drive the first connection arm and the second connection arm to rotate relative to each other around the shaft, the connector moving in the avoidance hole.

2. The gimbal of claim 1, wherein a centerline of the avoidance hole is in an arc shape centered on the shaft.

3. The gimbal of claim 1, wherein the second connection arm includes:
a body; and
a cover connected to the body and including a through-hole, a position of the through-hole corresponding to a position of the avoidance hole, and the connector passing through the through-hole to pass through the cover and be connected to the body.

4. The gimbal of claim 3, wherein a centerline of the through-hole is in an arc shape centered on the shaft.

5. The gimbal of claim 1, wherein the connector includes:
a conductive wire passing through the avoidance hole;
a first connection head connected to one end of the conductive wire and a first connection base of the first connection arm; and
a second connection head connected to another end of the conductive wire and a second connection base of the second connection arm.

6. The gimbal of claim 5, wherein the conductive wire includes:
a detachable first piece connected to the first connection head; and
a detachable second piece connected to the second connection head.

7. The gimbal of claim 1, wherein the shaft includes at least one of a yaw axis, a roll axis, or a pitch axis.

8. The gimbal of claim 1, wherein:
the first connection arm includes an avoidance space;
the avoidance hole communicates with the avoidance space; and
the connector and the second connection arm are partially located in the avoidance space.

9. The gimbal of claim 8, wherein the first connection arm includes a first wall, a connection wall, and a second wall connected in sequence to form a U shape as a whole, the first wall and the second wall being arranged at an interval to form the avoidance space.

10. The gimbal of claim 9, wherein the avoidance hole is arranged at at least one of the first wall or the second wall.

11. The gimbal of claim 9, wherein:
a first shaft hole is arranged at the first wall and/or the second wall;
a second shaft hole aligned with the first shaft hole is arranged at the second connection arm; and
the shaft passes through the first shaft hole and the second shaft hole.

12. The gimbal of claim 11, wherein:
the shaft is rotatably connected to the first wall and/or the second wall by bearings; and
the shaft is inserted in the second shaft hole to be fixedly connected to the second connection arm.

13. The gimbal of claim 11, wherein the shaft includes a screw inserted in the second shaft hole and connected to the second connection arm by a threaded connection.

14. The gimbal of claim 11, wherein:
the first shaft hole is arranged at a position close to a top of the first wall and/or a position close to a top of the second wall;
the second connection arm is further configured to be connected to a load; and
the second connection arm includes a weight structure, the weight structure and the load being located on two opposite sides of the shaft.

15. The gimbal of claim 9, wherein:
an accommodation slot is arranged on one side of the first wall away from the second wall;
the avoidance hole is arranged at a bottom of the accommodation slot;
the connector is partially accommodated in the accommodation slot; and
the first connection arm further includes an end cover detachably mounted at the first wall to shield the accommodation slot.

16. The gimbal of claim 15, further comprising:
a handle rotatably connected to connection wall;
wherein a connection hole is arranged at a bottom of the first wall and communicates with the accommodation slot to allow a connection wire of the handle to pass through the connection hole to enter the accommodation slot to be connected to a connection device of the first connection arm.

17. The gimbal of claim 1, wherein the gimbal includes a handheld gimbal or an onboard gimbal.

18. The gimbal of claim 1, wherein the motor is mounted at the second connection arm.

19. The gimbal of claim 1, wherein the connector is electrically connected to the motor.

20. A gimbal system comprising:
a gimbal including:
a shaft;
a first connection arm including an avoidance hole;
a second connection arm rotatably connected to the first connection arm; and
a connector passing through the avoidance hole, two ends of the connector being connected to the first connection arm and the second connection arm, respectively; and
a motor configured to drive the first connection arm and the second connection arm to rotate relative to each other around the shaft, the connector moving in the avoidance hole; and
a load mounted at the second connection arm;
wherein the second connection arm is configured to drive the load to rotate relative to the first connection arm when rotating relative to the first connection arm.
